(19) United States
(12) Patent Application Publication
(10) Pub. No.: US 2026/0260315 A1
(43) Pub. Date: Sep. 3, 2026

(54) ROBUST AUTOMATIC SCALE ESTIMATION FOR REAL OBJECTS

(71) Applicant: QUALCOMM Incorporated, San Diego, CA (US)

(72) Inventors: Robert Peter VIEHAUSER, Bad Hofgastein (AT); Julia HAUPTMANN, Salzburg (AT)

(21) Appl. No.: 19/067,715

(22) Filed: Feb. 28, 2025

Related U.S. Application Data
(60) Provisional application No. 63/721,225, filed on Nov. 15, 2024.

(51) Int. Cl. G06T 3/4023; G06T 5/70

(52) U.S. Cl. CPC G06T 3/4023; G06T 5/70

(57) ABSTRACT

Techniques and systems are provided for scale estimation. For instance, a process can include detecting an object in a first image; generating a predicted image of the object for a second viewpoint by applying a transformation to the first image captured from a first viewpoint using a hypothetical scale value; and comparing the predicted image of the object with a second image of the object captured from the second viewpoint to determine an actual scale value based on the hypothetical scale value.

### CROSS-REFERENCE TO RELATED APPLICATIONS

This application claims the benefit of U.S. Provisional Patent Application No. 63/721,225, filed Nov. 15, 2024, which is hereby incorporated by reference in its entirety and for all purposes.

### FIELD

This application is related to scale estimation. For example, aspects of the application relate to systems and techniques for robust automatic scale estimation for real objects.

### BACKGROUND

An extended reality (XR) (e.g., virtual reality, augmented reality, mixed reality) system can provide a user with a virtual experience by immersing the user in a completely virtual environment (made up of virtual content) and/or can provide the user with an augmented or mixed reality experience by combining a real-world or physical environment with a virtual environment.

One example use case for XR content that provides virtual, augmented, or mixed reality to users is to present a user with a “metaverse” experience. The metaverse is essentially a virtual universe that includes one or more three-dimensional (3D) virtual worlds. For example, a metaverse virtual environment may allow a user to virtually interact with other users (e.g., in a social setting, in a virtual meeting, etc.), to virtually shop for goods, services, property, or other item, to play computer games, and/or to experience other services.

In some cases, a user may be represented in a virtual environment (e.g., a metaverse virtual environment) as a virtual representation of the user, sometimes referred to as an avatar. To provide a more immersive experience, the avatar may be animated to reflect movement of the user. That is, the avatar may be animated based on how the user is moving. Techniques to improve how movements of the user are tracked may be useful.

### SUMMARY

Systems and techniques are described herein for displaying augmented reality enhanced media content. For example, aspects of the present disclosure relate to systems and techniques for reducing an effective latency by multi-sampling poses during reprojection. The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for an apparatus for scale estimation is provided. The apparatus includes at least one memory and at least one processor coupled to the at least one memory. The at least one processor is configured to: detect an object in a first image; generate a predicted image of the object for a second viewpoint by applying a transformation to the first image captured from a first viewpoint using a hypothetical scale value; and compare the predicted image of the object with a second image of the object captured from the second viewpoint to determine an actual scale value based on the hypothetical scale value.

As another example, a method for scale estimation is provided. The method includes: detecting an object in a first image; generating a predicted image of the object for a second viewpoint by applying a transformation to the first image captured from a first viewpoint using a hypothetical scale value; and comparing the predicted image of the object with a second image of the object captured from the second viewpoint to determine an actual scale value based on the hypothetical scale value.

A non-transitory computer-readable medium having stored thereon instructions is provided. The instructions, when executed by at least one processor, cause the at least one processor to: detect an object in a first image; generate a predicted image of the object for a second viewpoint by applying a transformation to the first image captured from a first viewpoint using a hypothetical scale value; and compare the predicted image of the object with a second image of the object captured from the second viewpoint to determine an actual scale value based on the hypothetical scale value.

As another example, an apparatus for scale estimation is provided. The apparatus includes: means for detecting an object in a first image; means for generating a predicted image of the object for a second viewpoint by applying a transformation to the first image captured from a first viewpoint using a hypothetical scale value; and means for comparing the predicted image of the object with a second image of the object captured from the second viewpoint to determine an actual scale value based on the hypothetical scale value.

In some aspects, one or more of the apparatuses described herein can include or be part of an extended reality device (e.g., a virtual reality (VR) device, an augmented reality (AR) device, or a mixed reality (MR) device), a mobile device (e.g., a mobile telephone or other mobile device), a wearable device (e.g., a network-connected watch or other wearable device), a personal computer, a laptop computer, a server computer, a television, a video game console, or other device. In some aspects, the one or more apparatuses can include at least one camera for capturing one or more images or video frames. For example, the one or more apparatuses can include a camera (e.g., an RGB camera) or multiple cameras for capturing one or more images and/or one or more videos including video frames. In some aspects, the one or more apparatuses can include a display for displaying one or more images, videos, notifications, or other displayable data. In some aspects, the one or more apparatuses can include at least one transmitter configured to transmit data or information over a transmission medium to at least one device. In some aspects, at least one processor of the one or more apparatuses can include a central processing unit (CPU), a digital signal processor (DSP), a graphics processing unit (GPU), a neural processing unit (NPU), a neural signal process (NSP), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an architecture of an image capture and processing system, in accordance with aspects of the present disclosure.

FIG. 2 is a diagram illustrating an architecture of an example extended reality (XR) system, in accordance with some aspects of the disclosure.

FIG. 3 illustrates an example of an augmented reality enhanced application engine, in accordance with aspects of the present disclosure.

FIG. 4A and FIG. 4B illustrate examples of physical scale for tracking, in accordance with aspects of the present disclosure.

FIG. 5 illustrates an example technique for scale estimation, in accordance with aspects of the present disclosure.

FIG. 6 is a chart illustrating how different scales can change photometric comparison scores, in accordance with aspects of the present disclosure.

FIG. 7 is a flow diagram illustrating a process for scale estimation, in accordance with aspects of the present disclosure.

FIG. 8 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

A camera (e.g., image capture device) is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

Degrees of freedom (DoF) refer to the number of basic ways a rigid object can move through three-dimensional (3D) space. In some cases, six different DoF can be tracked. The six degrees of freedom include three translational degrees of freedom corresponding to translational movement along three perpendicular axes. The three axes can be referred to as x, y, and z axes. The six degrees of freedom include three rotational degrees of freedom corresponding to rotational movement around the three axes, which can be referred to as pitch, yaw, and roll.

Extended reality (XR) systems or devices can provide virtual content to a user and/or can combine real-world or physical environments and virtual environments (made up of virtual content) to provide users with XR experiences. The real-world environment can include real-world objects (also referred to as physical objects), such as people, vehicles, buildings, tables, chairs, and/or other real-world or physical objects. XR systems or devices can facilitate interaction with different types of XR environments (e.g., a user can use an XR system or device to interact with an XR environment). XR systems can include virtual reality (VR) systems facilitating interactions with VR environments, augmented reality (AR) systems facilitating interactions with AR environments, mixed reality (MR) systems facilitating interactions with MR environments, and/or other XR systems. Examples of XR systems or devices include head-mounted displays (HMDs), smart glasses, among others. In some cases, an XR system can track parts of the user (e.g., a hand and/or fingertips of a user) to allow the user to interact with items of virtual content.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

Visual simultaneous localization and mapping (VSLAM) is a computational geometry technique used in devices with cameras, such as robots, head-mounted displays (HMDs), mobile handsets, and autonomous vehicles. In VSLAM, a device can construct and update a map of an unknown environment based on images captured by the device's camera. The device can keep track of the device's pose within the environment (e.g., location and/or orientation) as the device updates the map. For example, the device can be activated in a particular room of a building and can move throughout the interior of the building, capturing images. The device can map the environment, and keep track of its location in the environment, based on tracking where different objects in the environment appear in different images.

In the context of systems that track movement through an environment, such as XR systems and/or VSLAM systems, degrees of freedom can refer to which of the six degrees of freedom the system is capable of tracking. 3DoF systems generally track the three rotational DoF-pitch, yaw, and roll. A 3DoF headset, for instance, can track the user of the headset turning their head left or right, tilting their head up or down, and/or tilting their head to the left or right. 6DoF systems can track the three translational DoF as well as the three rotational DoF. Thus, a 6DoF headset, for instance, and can track the user moving forward, backward, laterally, and/or vertically in addition to tracking the three rotational DoF.

In some cases, an XR system may include remote body sensors, such as a hand controller, which may be used to specifically track movement of portions of the user's body, such as the hands or legs. For example, the remote body sensors may include internal measurement units (IMUs) for tracking movement. In some cases, the remote body sensors may be capable of tracking 3DoF or 6DoF movement of the portion of the body.

As noted previously, in some cases, an XR system may include remote body sensors, such as a hand controller, which may be used to specifically track movement of portions of the user's body, such as the hands or legs. For example, the remote body sensors may include internal measurement units (IMUs) for tracking movement. In some cases, the remote body sensors may be capable of tracking 3DoF or 6DoF movement of the portion of the body.

In some cases, an XR system may include an HMD display, such as AR HMD or AR glasses, that may be worn by a user of the XR system. Generally, it is desirable to keep an HMD display as light and small as possible. To help reduce the weight and the size of an HMD display, the HMD display may be a relatively lower power system (e.g., in terms of battery and computational power) as compared to a device (e.g., a companion device, such as a mobile phone, a server device, or other device) with which the HMD display is connected (e.g., wired or wireless connected). An HMD display may be a relatively lower power system (e.g., in terms of battery and/or computational power) to help reduce weight, size, and/or bulkiness of the HMD display.

As the HMD display may be a relatively low power device, the HMD display may be connected (e.g., wired or wireless connected) to another device (e.g., a mobile phone, a server device, or other device), referred to as a companion device. The companion device may be a relatively higher power system (e.g., in terms of battery and/or computational power) and may perform certain processing tasks for the HMD. For example, the companion device may perform processing tasks for generating information to be displayed on the HMD display. In some cases, such processing tasks may be split between the companion device and the HMD display.

In some cases, virtual content may be displayed over real-world objects by XR systems. To do this, the XR system may track the real-world object using a vision-based tracking system. For example, cameras of the XR system may capture images of the real-world object and the vision-based tracker may identify the location of the real-world object from frame to frame. In some cases, an XR system may include multiple cameras, for example to provide stereo images for a user of the XR system. For tracking, from the perspective of a first camera of the XR system, a scale does not really matter for tracking as the first camera observes a projection of the tracked target and the tracked target can be defined in any internal scale space. However, the scale of the object matters for the second camera as the second camera may have a different viewpoint of the object, which changes a perceived location of the object. An amount of change in perceived location may vary based on the scale.

In some cases, a scale estimate may be generated using multiple calibrated cameras to estimate a physical size of an object. For example, scale may be estimated by recognizing and tracking an object for each image from multiple cameras, determining poses for each image, and calculating a best fitting scale based on the two poses. However, this solution may rely on accurate recognition and tracking for both cameras and using temporally aligned frames, which can be difficult. Alternatively, a physical scale may be inferred based on depth information, for example from an active depth sensor (time-of-flight, structured light, and the like), or via an ML model trained to perform depth estimation. However, active depth sensors may have range limitations and increased power consumption. Similarly, ML based solutions may have relatively large error margins and may also increase power consumption. Improved techniques for scale estimation may thus be useful.

Systems, apparatuses, electronic devices, methods (also referred to as processes), and computer-readable media (collectively referred to herein as “systems and techniques”) are described herein that provide robust automatic scale estimation for real objects. In some cases, it may be useful to exploit existing knowledge of camera calibration information and a pose between a target and a first camera to formulate a scale estimation problem as a one-dimensional optimization problem. For example, a device (e.g., an XR application engine of an XR device, such as an AR application engine of an AR device) may detect and/or track an object in a first image, for example, using a first camera having a first viewpoint of the object. A predicted image of the object may be generated from the first image. The predicted image may be generated from a second viewpoint associated with a second camera. The predicted image may be generated by applying a transformation to the first image using a hypothetical scale value. The predicted image of the object may then be compared to a second image of the object. The second image of the object may be captured by a second camera from the second viewpoint and the actual scale value for the object may be determined based on the comparison. The transformation may be converted to describe a relationship between an internal scale space associated with the first image and a metric scale space.

In some cases, the comparison may be a photometric comparison between the predicted image of the object and the second image of the object, such as a normalized cross coefficient or normalized cross correlation. A photometric comparison may compare a brightness and/or intensity of corresponding pixels of two images.

The hypothetical scale value may be selected from a range of possible values such that the selected hypothetical scale values generate at least a one-pixel shift in the predicted image as compared to other predicted images of the object. The hypothetical scale value may be from a set of significant scale values, where the significant scale values are selected to generate at least a one-pixel shift in the predicted image of the object. In some cases, predicted images may be generated for each significant scale value. In other cases, certain significant scale values of the set of significant scale values may be skipped, so no predicted image may be generated based on the skipped significant scale values. In some cases, blurring may be applied to the predicted image of the object and the second image of the object before comparing the predicted image of the object with second image of the object. Blurring may allow additional significant scale values to be skipped.

Various aspects of the application will be described with respect to the figures.

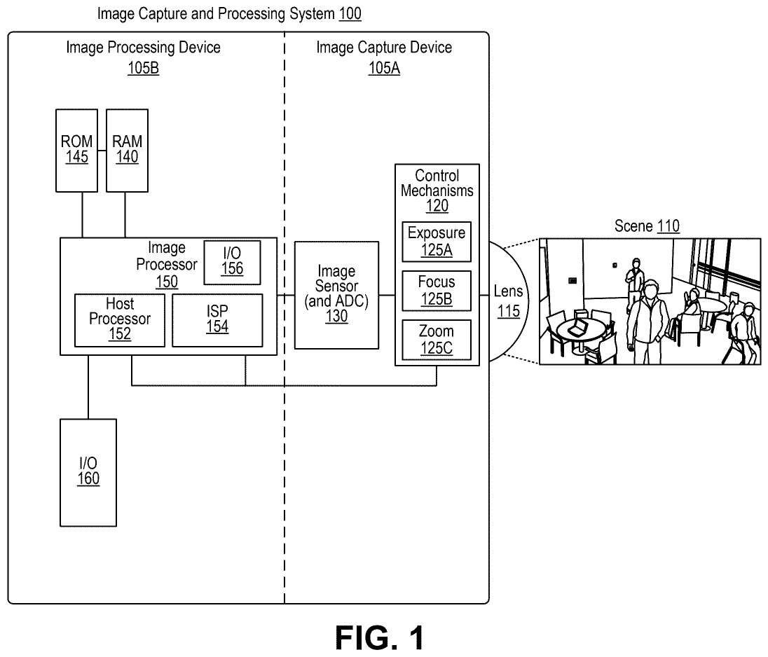

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by the one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the one or more control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the one or more control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the one or more control mechanisms 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the one or more control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the one or more control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image capture and processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

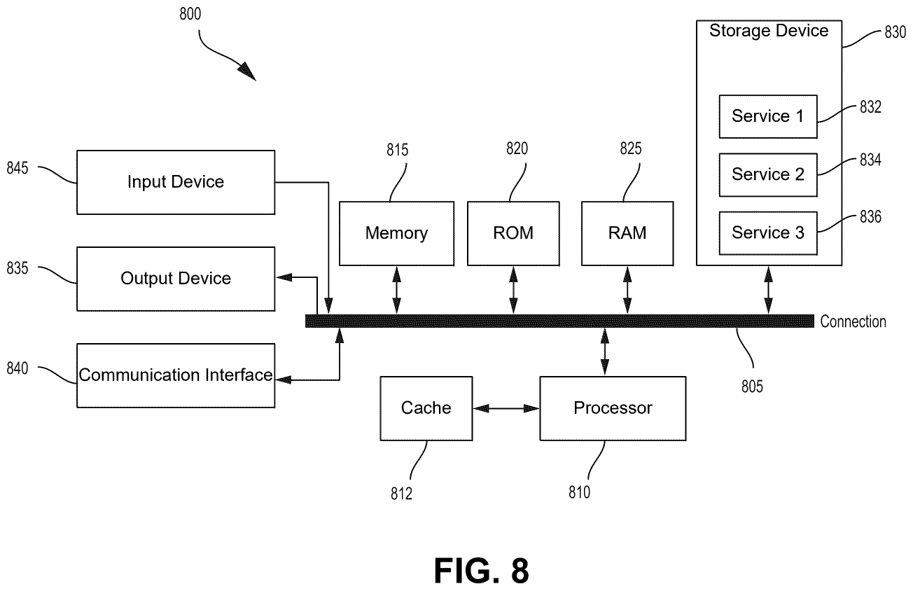

The image processor 150 may include one or more processors, such as one or more image signal processors (ISPs) (including ISP 154), one or more host processors (including host processor 152), and/or one or more of any other type of processor 910 discussed with respect to the computing system 800 of FIG. 8. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1035, any other input devices 1045, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, one or more control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

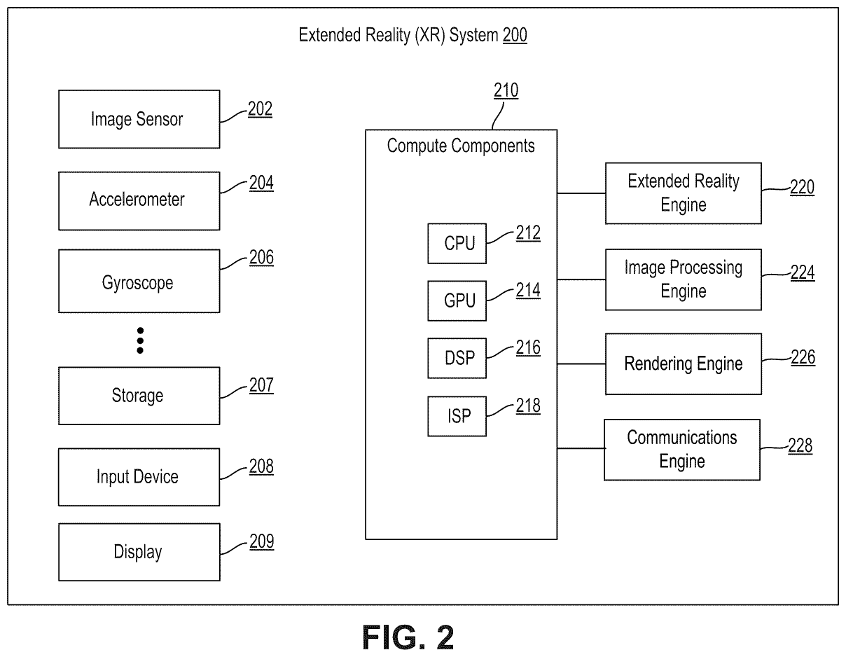

In some examples, the extended reality (XR) system 200 of FIG. 2 can include the image capture and processing system 100, the image capture device 105A, the image processing device 105B, or a combination thereof.

FIG. 2 is a diagram illustrating an architecture of an example extended reality (XR) system 200, in accordance with some aspects of the disclosure. The XR system 200 can run (or execute) XR applications and implement XR operations. In some examples, the XR system 200 can perform tracking and localization, mapping of an environment in the physical world (e.g., a scene), and/or positioning and rendering of virtual content on a display 209 (e.g., a screen, visible plane/region, and/or other display) as part of an XR experience. For example, the XR system 200 can generate a map (e.g., a three-dimensional (3D) map) of an environment in the physical world, track a pose (e.g., location and position) of the XR system 200 relative to the environment (e.g., relative to the 3D map of the environment), position and/or anchor virtual content in a specific location(s) on the map of the environment, and render the virtual content on the display 209 such that the virtual content appears to be at a location in the environment corresponding to the specific location on the map of the scene where the virtual content is positioned and/or anchored. The display 209 can include a glass, a screen, a lens, a projector, and/or other display mechanism that allows a user to see the real-world environment and also allows XR content to be overlaid, overlapped, blended with, or otherwise displayed thereon.

In this illustrative example, the XR system 200 includes one or more image sensors 202, an accelerometer 204, a gyroscope 206, storage 207, compute components 210, an XR engine 220, an image processing engine 224, a rendering engine 226, and a communications engine 228. It should be noted that the components 202-228 shown in FIG. 2 are non-limiting examples provided for illustrative and explanation purposes, and other examples can include more, fewer, or different components than those shown in FIG. 2. For example, in some cases, the XR system 200 can include one or more other sensors (e.g., one or more inertial measurement units (IMUs), light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one more other processing engines, one or more other hardware components, and/or one or more other software and/or hardware components that are not shown in FIG. 2. While various components of the XR system 200, such as the image sensor 202, may be referenced in the singular form herein, it should be understood that the XR system 200 may include multiple of any component discussed herein (e.g., multiple image sensors 202).

The XR system 200 includes or is in communication with (wired or wirelessly) an input device 208. The input device 208 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, remote body sensor, handheld controller, any other input device 845 discussed herein, or any combination thereof. In some cases, the image sensor 202 can capture images that can be processed for interpreting gesture commands.

The XR system 200 can also communicate with one or more other electronic devices (wired or wirelessly). For example, communications engine 228 can be configured to manage connections and communicate with one or more electronic devices. In some cases, the communications engine 228 can correspond to the communications interface 840 of FIG. 8.

In some implementations, the one or more image sensors 202, the accelerometer 204, the gyroscope 206, storage 207, compute components 210, XR engine 220, image processing engine 224, and rendering engine 226 can be part of the same computing device. For example, in some cases, the one or more image sensors 202, the accelerometer 204, the gyroscope 206, storage 207, compute components 210, XR engine 220, image processing engine 224, and rendering engine 226 can be integrated into an HMD, extended reality glasses, smartphone, laptop, tablet computer, gaming system, and/or any other computing device. However, in some implementations, the one or more image sensors 202, the accelerometer 204, the gyroscope 206, storage 207, compute components 210, XR engine 220, image processing engine 224, and rendering engine 226 can be part of two or more separate computing devices. For example, in some cases, some of the components 202-226 can be part of, or implemented by, one computing device and the remaining components can be part of, or implemented by, one or more other computing devices.

The storage 207 can be any storage device(s) for storing data. Moreover, the storage 207 can store data from any of the components of the XR system 200. For example, the storage 207 can store data from the image sensor 202 (e.g., image or video data), data from the accelerometer 204 (e.g., measurements), data from the gyroscope 206 (e.g., measurements), data from the compute components 210 (e.g., processing parameters, preferences, virtual content, rendering content, scene maps, tracking and localization data, object detection data, privacy data, XR application data, face recognition data, occlusion data, etc.), data from the XR engine 220, data from the image processing engine 224, and/or data from the rendering engine 226 (e.g., output frames). In some examples, the storage 207 can include a buffer for storing frames for processing by the compute components 210.

The one or more compute components 210 can include a central processing unit (CPU) 212, a graphics processing unit (GPU) 214, a digital signal processor (DSP) 216, an image signal processor (ISP) 218, and/or other processor (e.g., a neural processing unit (NPU) implementing one or more trained neural networks). The compute components 210 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 210 can implement (e.g., control, operate, etc.) the XR engine 220, the image processing engine 224, and the rendering engine 226. In other examples, the compute components 210 can also implement one or more other processing engines.

The image sensor 202 can include any image and/or video sensors or capturing devices. In some examples, the image sensor 202 can be part of a multiple-camera assembly, such as a dual-camera assembly. The image sensor 202 can capture image and/or video content (e.g., raw image and/or video data), which can then be processed by the compute components 210, the XR engine 220, the image processing engine 224, and/or the rendering engine 226 as described herein. In some examples, the image sensors 202 may include an image capture and processing system 100, an image capture device 105A, an image processing device 105B, or a combination thereof.

In some examples, the image sensor 202 can capture image data and can generate images (also referred to as frames) based on the image data and/or can provide the image data or frames to the XR engine 220, the image processing engine 224, and/or the rendering engine 226 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, the image sensor 202 (and/or other camera of the XR system 200) can be configured to also capture depth information. For example, in some implementations, the image sensor 202 (and/or other camera) can include an RGB-depth (RGB-D) camera. In some cases, the XR system 200 can include one or more depth sensors (not shown) that are separate from the image sensor 202 (and/or other camera) and that can capture depth information. For instance, such a depth sensor can obtain depth information independently from the image sensor 202. In some examples, a depth sensor can be physically installed in the same general location as the image sensor 202, but may operate at a different frequency or frame rate from the image sensor 202. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The XR system 200 can also include other sensors in its one or more sensors. The one or more sensors can include one or more accelerometers (e.g., accelerometer 204), one or more gyroscopes (e.g., gyroscope 206), and/or other sensors. The one or more sensors can provide velocity, orientation, and/or other position-related information to the compute components 210. For example, the accelerometer 204 can detect acceleration by the XR system 200 and can generate acceleration measurements based on the detected acceleration. In some cases, the accelerometer 204 can provide one or more translational vectors (e.g., up/down, left/right, forward/back) that can be used for determining a position or pose of the XR system 200. The gyroscope 206 can detect and measure the orientation and angular velocity of the XR system 200. For example, the gyroscope 206 can be used to measure the pitch, roll, and yaw of the XR system 200. In some cases, the gyroscope 206 can provide one or more rotational vectors (e.g., pitch, yaw, roll). In some examples, the image sensor 202 and/or the XR engine 220 can use measurements obtained by the accelerometer 204 (e.g., one or more translational vectors) and/or the gyroscope 206 (e.g., one or more rotational vectors) to calculate the pose of the XR system 200. As previously noted, in other examples, the XR system 200 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the XR system 200, using a combination of one or more accelerometers, one or more gyroscopes, and/or one or more magnetometers. In some examples, the one or more sensors can output measured information associated with the capture of an image captured by the image sensor 202 (and/or other camera of the XR system 200) and/or depth information obtained using one or more depth sensors of the XR system 200.

The output of one or more sensors (e.g., the accelerometer 204, the gyroscope 206, one or more IMUs, and/or other sensors) can be used by the XR engine 220 to determine a pose of the XR system 200 (also referred to as the head pose) and/or the pose of the image sensor 202 (or other camera of the XR system 200). In some cases, the pose of the XR system 200 and the pose of the image sensor 202 (or other camera) can be the same. The pose of image sensor 202 refers to the position and orientation of the image sensor 202 relative to a frame of reference (e.g., with respect to the scene 110). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees Of Freedom (3DoF), which refers to the three angular components (e.g. roll, pitch, and yaw).

In some cases, a device tracker (not shown) can use the measurements from the one or more sensors and image data from the image sensor 202 to track a pose (e.g., a 6DoF pose) of the XR system 200. For example, the device tracker can fuse visual data (e.g., using a visual tracking solution) from the image data with inertial data from the measurements to determine a position and motion of the XR system 200 relative to the physical world (e.g., the scene) and a map of the physical world. As described below, in some examples, when tracking the pose of the XR system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the XR system 200 within the scene and the 3D map of the scene, etc. The 3D map can provide a digital representation of a scene in the real/physical world. In some examples, the 3D map can anchor location-based objects and/or content to real-world coordinates and/or objects. The XR system 200 can use a mapped scene (e.g., a scene in the physical world represented by, and/or associated with, a 3D map) to merge the physical and virtual worlds and/or merge virtual content or objects with the physical environment.

In some aspects, the pose of image sensor 202 and/or the XR system 200 as a whole can be determined and/or tracked by the compute components 210 using a visual tracking solution based on images captured by the image sensor 202 (and/or other camera of the XR system 200). For instance, in some examples, the compute components 210 can perform tracking using computer vision-based tracking, model-based tracking, and/or simultaneous localization and mapping (SLAM) techniques. SLAM refers to a class of techniques where a map of an environment (e.g., a map of an environment being modeled by XR system 200) is created while simultaneously tracking the pose of a camera (e.g., image sensor 202) and/or the XR system 200 relative to that map. The map can be referred to as a SLAM map, and can be three-dimensional (3D). The SLAM techniques can be performed using color or grayscale image data captured by the image sensor 202 (and/or other camera of the XR system 200), and can be used to generate estimates of 6DoF pose measurements of the image sensor 202 and/or the XR system 200. Such a SLAM technique configured to perform 6DoF tracking can be referred to as 6DoF SLAM. In some cases, the output of the one or more sensors (e.g., the accelerometer 204, the gyroscope 206, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 202 (and/or other camera) to the SLAM map. For example, 6DoF SLAM can use feature point associations from an input image to determine the pose (position and orientation) of the image sensor 202 and/or XR system 200 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 202 and/or the XR system 200 can be determined by projecting features from the 3D SLAM map into an image or video frame and updating the camera pose from verified 2D-3D correspondences.

In one illustrative example, the compute components 210 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 210 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 200 can also track the hand and/or fingers of the user to allow the user to interact with and/or control virtual content in a virtual environment. For example, the XR system 200 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

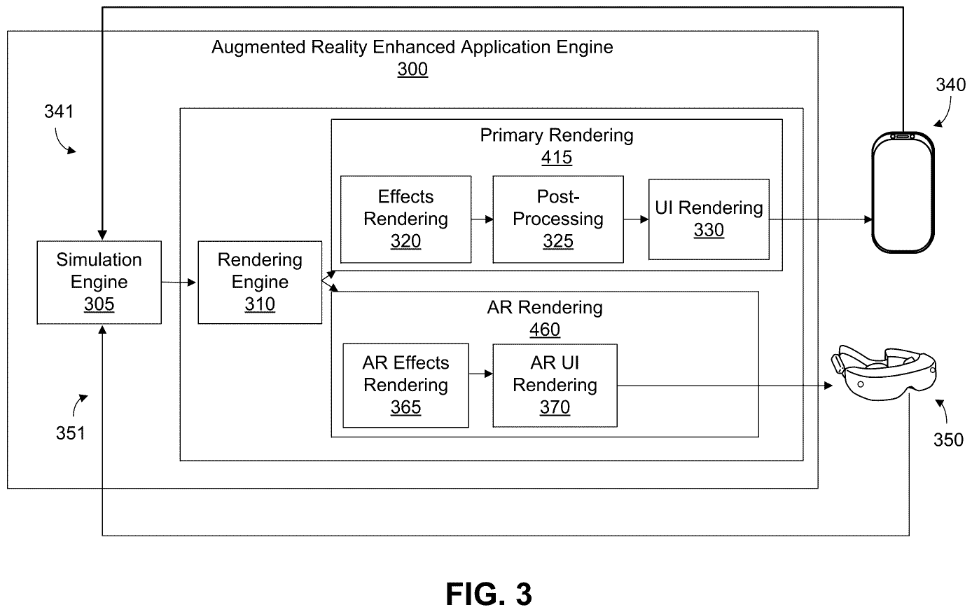

FIG. 3 illustrates an example of an augmented reality enhanced application engine 300, in accordance with aspects of the present disclosure. In the illustrative example, the augmented reality enhanced application engine 300 includes a simulation engine 305, a rendering engine 310, a primary rendering module 315, and AR rendering module 360. As illustrated, the primary rendering module 315 can include an effects rendering engine 320, a post-processing engine 325, and a user interface (UI) rendering engine 330. The AR rendering module 360 can include an AR effects rendering engine 365 and an AR UI rendering engine 370. It should be noted that the components 305-370 shown in FIG. 3 are non-limiting examples provided for illustrative and explanation purposes, and other examples can include more, fewer, or different components than those shown in FIG. 3.

In some cases, the augmented reality enhanced application engine 300 is included in and/or is in communication with (wired or wirelessly) a mobile device 340. In some examples, the augmented reality enhanced application engine 300 is included in and/or is in communication with (wired or wirelessly) an XR system 350.

In the illustrated example of FIG. 3, the simulation engine 305 can generate a simulation for the augmented reality enhanced application engine 300. In some cases, the simulation can include, for example, one or more images, one or more videos, one or more strings of characters (e.g., alphanumeric characters, numbers, text, Unicode characters, symbols, and/or icons), one or more two-dimensional (2D) shapes (e.g., circles, ellipses, squares, rectangles, triangles, other polygons, rounded polygons with one or more rounded corners, portions thereof, or combinations thereof), one or more three-dimensional (3D) shapes (e.g., spheres, cylinders, cubes, pyramids, triangular prisms, rectangular prisms, tetrahedrons, other polyhedrons, rounded polyhedrons with one or more rounded edges and/or corners, portions thereof, or combinations thereof), textures for shapes, bump-mapping for shapes, lighting effects, or combinations thereof. In some examples, the simulation can include at least a portion of an environment. The environment may be a real-world environment, a virtual environment, and/or a mixed environment that includes real-world environment elements and virtual environment elements.

In some cases, the simulation generated by the simulation engine 305 can be dynamic. For example, the simulation engine 305 can update the simulation based on different triggers, including, without limitation, physical contact, sounds, gestures, input signals, passage of time, and/or any combination thereof. As used herein, an application state of the augmented reality enhanced application engine 300 can include any information associated with the simulation engine 305, rendering engine 310, primary rendering module 315, effects rendering engine 320, post-processing engine 325, UI rendering engine 330, AR rendering module 360, AR effects rendering engine 365, AR UI rendering engine 370, inputs to the augmented reality enhanced application engine 300, outputs from the augmented reality enhanced application engine 300, and/or any combination thereof at a particular moment in time.

As illustrated, the simulation engine 305 can obtain mobile device input 341 from the mobile device 340. In some cases, the simulation engine 305 can obtain XR system input 351 from the XR system 350. The mobile device input 341 and/or XR system input 351 can include, for example, user input through a user interface of the application displayed on the display of the mobile device 340, user inputs from an input device (e.g., input device 208 of FIG. 2), one or more sensors (e.g., image sensor 202, accelerometer 204, gyroscope 206 of FIG. 2). In some cases, simulation engine 305 can update the application state for the augmented reality enhanced application engine 300 based on the mobile device input 341, XR system input 351, and/or any combination thereof.

In the illustrative example of FIG. 3, the rendering engine 310 can obtain application state information from the simulation engine 305. In some cases, the rendering engine 310 can determine portions of the application state information to be rendered by the displays available to the augmented reality enhanced application engine 300. For example, the rendering engine rendering engine 310 can determine whether a connection (wired or wireless) has been established between the XR system 350 and the mobile device 340. In some cases, the rendering engine 310 can determine the application state information to be rendered by the primary rendering module 315 and the AR rendering module 360. In some cases, the rendering engine 310 can determine that the XR system 350 is not connected (wired or wirelessly) to the mobile device 340. In some cases, the rendering engine 310 can determine the application state information for the primary rendering module 315 and forego determining application state information to be rendered by the AR rendering module 360 that will not be displayed. Accordingly, the rendering engine 310 can facilitate an adaptive rendering configuration for the augmented reality enhanced application engine 300 based on the availability and/or types of available displays. In some implementations, a separate rendering engine 310 as shown in FIG. 3 may be excluded. In one illustrative example, the primary rendering module 315 and/or AR rendering module 360 can include at least a portion of the functionality of the rendering engine 310 described above.

The primary rendering module 315 can include an effects rendering engine 320, post-processing engine 325, and UI rendering engine 330. In some cases, the primary rendering module 315 can render image frames configured for display on a display of the mobile device 340. As illustrated, the primary rendering module 315 can output the generated image frames (e.g., media content) to be displayed on a display of the mobile device 340. In some cases, the effects rendering information can render application state information generated by the simulation engine 305. For example, the effects rendering engine can generate a 2D projection of a portion of a 3D environment included in the application state information. For example, the rendering engine 320 may generate a perspective projection of the 3D environment by a virtual camera. In some cases, the application state information can include a pose of the virtual camera within the environment. In some cases, the effects rendering engine 320 can generate additional visual effects that are not included within the 3D environment. For example, the rendering engine 320 can apply texture maps to enhance the visual appearance of the effects generated by the 320. In some cases, the rendering engine 320 can exclude portions of the application state information designated for the AR rendering module 360 by the rendering engine 310. For example, the primary rendering module 315 may exclude effects present in the environment of the simulation.

In some cases, the post-processing engine 325 can provide additional processing to the rendered effects generated by the effects rendering engine 320. For example, the post-processing engine 325 can perform scaling, image smoothing, z-buffering, contrast enhancement, gamma, color mapping, any other image processing, and/or any combination thereof.

In some implementations, UI rendering engine 330 can render a UI. In some cases, the user interface can provide application state information in addition to the effects rendered based on the application environment (e.g., a 3D environment). In some cases, the UI can be generated as an overlay over a portion of the image frame output by the post-processing engine 325.

The AR rendering module 360 can include an AR effects rendering engine 365 and an AR UI rendering engine 370. In some cases, the AR effects rendering engine 365 can render application state information generated by the simulation engine 305. For example, the AR effects rendering engine 365 can generate a 2D projection of a 3D environment included in the application state information. In some cases, the AR effects rendering engine 365 can generate effects that appear to protrude out from the display surface of the display of the mobile device 340.

In some cases, the display of the XR system 350 can have different display parameters (e.g., a different resolution, frame rate, aspect ratio, and/or any other display parameters) than the display of the mobile device 340. In some cases, the display parameters can also vary between different types of output devices (e.g., different HMD models, other XR systems, or the like). As a result, rendering display data for the XR system 350 with the AR rendering module 360 can affect performance of the primary rendering module 315 (e.g., by consuming computational resources of a GPU, CPU, memory, or the like). In some cases, inclusion of the AR rendering module 360 within the augmented reality enhanced application engine 300 can require periodic updates to provide compatibility with different devices.

Virtual content may be displayed over real-world objects by XR systems. For example, an XR system may overlay virtual content on a real-world object to augment the real-world object. To do this, the XR system may track the real-world object using a vision-based tracking system where cameras of the XR system capture images of the real-world object and the vision-based tracker may identify the location of the real-world object from frame to frame. In some cases, from the perspective of a first camera of the XR system, the scale does not really matter for tracking as the first camera observes a projection of the tracked target and the tracked target can be defined in any internal scale space, which may influence the norm of the translation vector of the estimated object-to-camera pose. As the frame of reference for the tracking and placing the augmentation is the same (e.g., from the same camera), the scale can be the same. However, if this pose is sent to another entity in a different scale space, such as a metric model of the location of a second camera or display, the physical scale should be known to translate the pose observed by the first camera to the metric model scale space so that an augmentation displayed using the second camera aligns properly with the object.

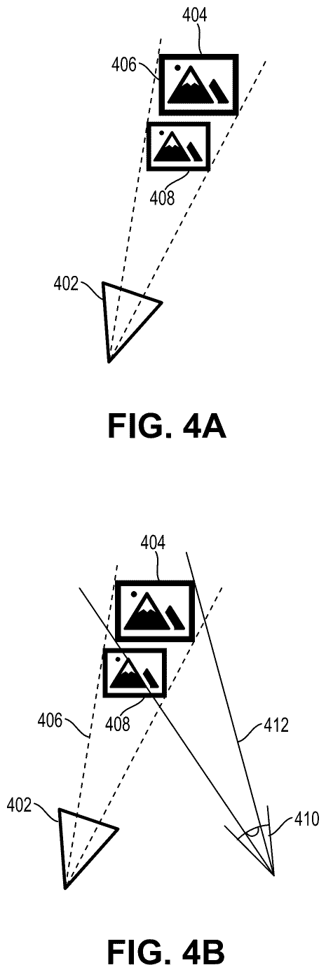

FIGS. 4A and 4B illustrate examples of physical scale for tracking, in accordance with aspects of the present disclosure. In FIG. 4A, a first camera 402 may be pointed toward an object 404. In some cases, the object 404 may be identified and/or tracked using any technique for object recognition/object identification and/or object tracking. Examples of these techniques may include YOLO, MobileNet, Cascade R-CNN, ByteTrack, DeepSORT, and the like. From a perspective 406 of the first camera 402, an augmentation at any scale, such as scale 408, along the perspective 406 may align with the object 404. Tracking using a single camera, such as the first camera 402 may be performed using any scale, such as by assigning a longest side of the object 404 as 1 in an internal scale and scaling movement based on this internal scale.

As shown in FIG. 4B, adding a second camera 410 (or an eye observing through a transparent display) positioned at a different location may, due to parallax, have a different perspective 412 of the object 404. If the wrong physical scale is used, such as scale 408, then there may be a positional shift in the augmentation from the different perspective 412. Additionally, an incorrect physical scale assumption may cause errors in an estimated physical distance to the target, potentially resulting in occlusion errors, or other possible impacts in cases where the XR experience relies on correct spatial target localization.

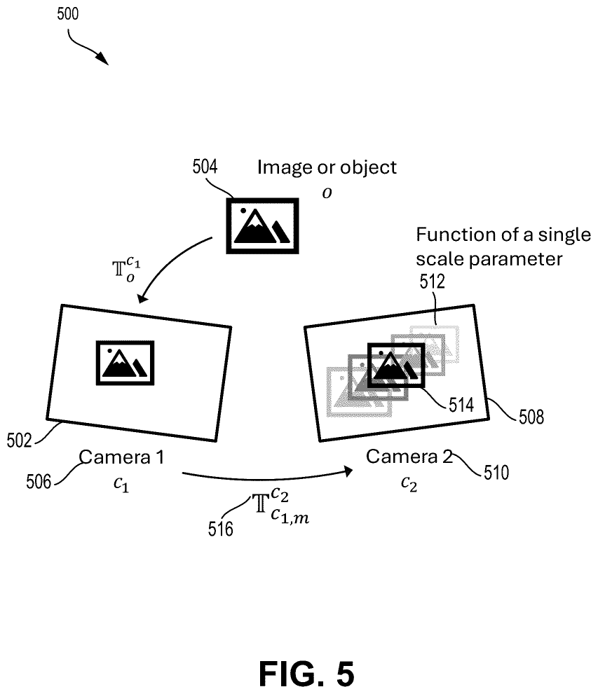

In some cases, it may be useful to leverage knowledge of the camera calibration and the pose between target and a first camera to formulate the scale estimation problem as a one-dimensional optimization problem. FIG. 5 illustrates an example technique for scale estimation 500, in accordance with aspects of the present disclosure. In some cases, based on the known camera calibration and pose (described by a transformation

$${𝕋}_{o}^{{c}_{1}} ) ,$$

each pixel of a first image 502 of a target 504 (e.g., object, image, etc.) from a tracking camera, such as a first camera 506 (c₁) from a first viewpoint of the target 504, can be mapped (e.g., via a transformation between cameras 516

$${𝕋}_{{c}_{1 , m}}^{{c}_{2}} )$$

to exactly one location (e.g., pixel) for a second image 508 captured by a second camera 510 (c₂) from a second viewpoint of the target 504 using a hypothetical scale value (e.g., scale hypothesis, scale estimate). A hypothetical scale value may be a scale value used to generate a predicted image where the actual (e.g., physical) scale is unknown and a set of hypothetical scale values may be a set of scale values within a range of scale values. Multiple predicted images may be generated across the set of hypothetical scale values.

Optimizing this hypothetical scale may be performed by aligning predicted images 512 of the target 504 from the first image 502 that have been generated based on different hypothetical scale values with an actual image 514 of the target 504 from the second camera 510. A predicted image, of the predicted images 512, may be a representation of pixels that have been projected from the first image 502 using a particular scale hypothesis for comparison against the actual image 514 (e.g., second image) and each predicted image may be a function of a single different scale value. In some cases, a photometric comparison may be used to determine whether a predicted image of the predicted images 512 aligns with the actual image 514. This photometric comparison may be derivable in order to formulate a non-linear optimization problem. In some cases, as the search (e.g., optimization) may be performed in a one-dimensional parameter space (e.g., a scale space) by increasing and/or decreasing a scale value, the search may be robust and efficient to calculate.

In some cases, the translation along the projected line of sight of the first camera may not be the only difference between projected versions of the target under a different scale. Thus, the exact mapping may be derived in 3D and may depend on an arrangement and properties of the cameras.

In some cases, operations to model a projection of 3D points in an object space or image space into a 2D image taken by a camera may be described by mapping 3D points x_{3D}_{ₒ} to a camera (e.g., generic camera c of target o) by a transformation

$${𝕋}_{o}^{c}$$

consisting of a rotation matrix

$${ℝ}_{o}^{c}$$

and a translation vector

$${\vec{t}}_{o}^{c} ,$$

such that

$${𝕋}_{o}^{c} = ( {ℝ}_{o}^{c} \vert {\vec{t}}_{o}^{c} ) .$$

A full projection model (P_{c}) to project 3D points in the camera system onto the image plane of the camera may include a linear projection defined by principal point and focal length, as well as an optional distortion model to model lens distortions of the camera, such that

$${x}_{2 {D}_{c}} = {P}_{c} ( {𝕋}_{o}^{c} ( {x}_{3 {D}_{o}} ) ) .$$

In some cases, the scale space of the translational part

$${\vec{t}}_{o}^{c}$$

of

$${𝕋}_{o}^{c}$$

and the scale space in which the 3D points are defined should match. The scale space may define where the target is projected in the camera for the augmentation and the scale space may match a physical scale so that other cameras separate from a tracking camera can align augmentations to the target. The scale space may be remapped using coordinate scaling so multiple (e.g., 2) scale spaces may be used: m for metric, and int for an internal scale of the object coordinates. In some cases, the internal scale space may be the scale used by the first camera 506 for tracking associated with the first image 502. The metric scale space may be a physical scale space based on physical world distances.

Connecting the two scale spaces (e.g., internal scale space and metric scale space) may be performed using scale hypothesis. For example, a fixed metric transformation between the first camera 506 and the second camera 510 may be defined as

$${𝕋}_{{c}_{1} , m}^{{c}_{2}}$$

and a fixed projection of the second camera 510 may be defined as P_{c}_{₂}, so that a 2D point projected to the second image 508 may be expressed as

$${x}_{2 {D}_{{c}_{2}}} ( s ) = {P}_{{c}_{2}} ( {𝕋}_{{c}_{1} , m}^{{c}_{2}} ( {𝕋}_{o , m}^{{c}_{1}} ( 𝕊 ( {x}_{3 {D}_{o , int}} , s ) , s ) ) ) ,$$

where the metric transformation

$$( {𝕋}_{o , m}^{{c}_{1}} )$$

of the object from the first image 502 is

$${𝕋}_{o , m}^{{c}_{1}} ( s ) = ( {ℝ}_{o}^{{c}_{1}} \vert {\vec{t}}_{o , m}^{{c}_{1}} ) = ( {ℝ}_{o}^{{c}_{1}} \vert s \cdot {\vec{t}}_{o , int}^{{c}_{1}} ) .$$

Of note, the translational portion,

$${\vec{t}}_{o , int}^{{c}_{1}}$$

is scaled (e.g., multiplied by s), but the rotational portion is not scaled.

A scaling function [symbol] may be expressed as 3D points multiplied by a physical scale s, such that [symbol] (x, s)=s·x. Thus, the scaling function [symbol] and the transformation

$${𝕋}_{o , m}^{{c}_{1}}$$

depend on the physical scale s, which is the subject of the search. In some cases, deriving a full chain for searching for s may be calculation intensive as such a chain may include stepping through a set of float values across a search range.

The different images (e.g., first image 502 and second image 508) may not be time aligned in some cases. In cases where the device (e.g., device including the first camera 506 and second camera 510) is moving, a small offset pose based on the relative motion of the device may be added to the functions discussed above. The small offset pose based on the relative motion of the device may be used whether the object is in motion or not in motion. In some cases, the photometric comparison and optimization to determine the scale may be performed by more than a pair of cameras. In some cases, using more than two cameras can significantly increase the accuracy. More than two cameras may be used, for example, by using a single tracking image (e.g., the first image 502 in the example above) and using multiple frames for comparison. In some cases, image data for multiple frames may be aggregated for the photometric comparison from different frame pairs or tuples over time and a single scale optimization may be used over the aggregated frames. Doing so may increase accuracy or detect if the scale is changing over time (e.g., when tracking an image target off a screen which zooms in and out).

In some cases, the projection of the 2D point to the second image 508 from the first image 502 may be simplified by framing the problem in the internal object scale space (e.g., x_{3D}_{_{o.int}}). This may be performed as the projections of the images do not change with the scale space. Reformulating the fixed metric transformation between the first camera 506 and the second camera 510

$${𝕋}_{{c}_{1} , m}^{{c}_{2}}$$

based on the internal scale may be performed by rescaling using an inverse scale sᵢₙᵥ (e.g., dividing the translation vector by the scale) such that

$${𝕋}_{{c}_{1 , int}}^{{c}_{2}} ( {s}_{inv} ) = ( {ℝ}_{{c}_{1}}^{{c}_{2}} \vert {\vec{t}}_{{c}_{1} , int}^{{c}_{2}} ) = ( {ℝ}_{{c}_{1}}^{{c}_{2}} \vert {s}_{inv} \cdot {\vec{t}}_{{c}_{1} , m}^{{c}_{2}} ) .$$

The transformation between the first camera 506 and the second camera 510

$${𝕋}_{{c}_{1} , m}^{{c}_{2}}$$

may then be expressed as

$${x}_{2 {D}_{{c}_{2}}} ( s ) = {P}_{{c}_{2}} ( {𝕋}_{{c}_{1 , int}}^{{c}_{2}} ( {𝕋}_{o , int}^{{c}_{1}} ( {x}_{3 {D}_{o , int}} ) , {s}_{inv} ) ) ,$$

where

$${s}_{inv} = \frac{1}{s} .$$

In this formulation, only one variable appears early in a reverse operation chain that is dependent on the scale being optimized (e.g., optimization variable) making the simplified formulation easier to derive and determine.

In some cases, to optimize the scale, multiple scale estimates within a range (e.g., 1 cm-20 m) of scales may be made and the target 504 in the first image 502 may be transformed via the transformations discussed above to generate predicted images 512 corresponding to the multiple scale estimates. Predicted images 512 may be matched against the actual image 514 to determine the physical scale. In some cases, the image matching may be performed based on a photometric comparison. A photometric comparison may compare a brightness and/or intensity of corresponding pixels of two images. Examples of photometric comparisons that may be performed may include cross coefficient, cross correlation, normalized cross coefficient, normalized cross correlation, sum of squared differences, sum of absolute differences, normalized sum of squared differences, normalized sum of absolute differences, etc.

In some cases, rather than attempting to calculate predicted images for every scale within the range, it may be useful to have a mechanism to determine a first initial guess of the scale to help converge to a solution with fewer iterations. As a photometric comparison in pixel space is used, it may be useful to pre-calculate a set of scale values which result in a 1-pixel shift in the second camera image. For example, the photometric comparison may be, at most, a pixel by pixel match (or a match performed on a subset of pixels) of the target, so scale values that can result in a single pixel shift may matter as compared to scale values that cause a less than one pixel shift (which may not be detectable by the photometric comparison). As the pose and distance between the first camera 506 and second camera 510 are known, the scale values (e.g., distance values) that may cause at least a single pixel shift (e.g., a predicted image that is shifted at least one pixel) may be determined through trigonometric calculations. A set of significant scale values (e.g., scale values that may cause at least a single pixel shift) may be predetermined. In some cases, the differences in scales to cause a pixel shift can be non-linear and can be dependent on a size of the object. The significant scale values may then be used to generate the predicted images 512 for matching against the actual image 514.

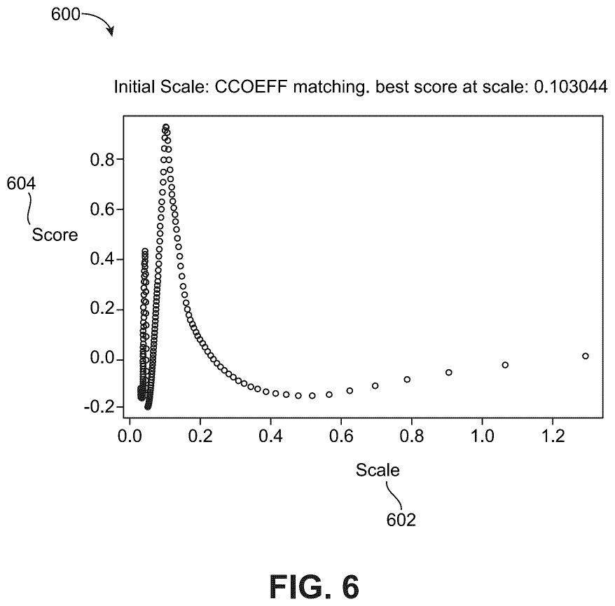

FIG. 6 is a chart 600 illustrating how different scales can change photometric comparison scores, in accordance with aspects of the present disclosure. In chart 600, significant scale values 602 are shown on the X-axis, ranging from 0 to 1.4 m, and photometric comparison scores 604, such as a score determined based on a normalized cross coefficient, are shown on the Y-axis. Each point on the chart 600 represents a scale (e.g., distance from the first camera 506 of FIG. 5) value (e.g., significant scale value) that can cause at least a one pixel shift and a corresponding score from the photometric comparison between a predicted image associated with the significant scale value and the actual image. In this example, a higher score from the photometric comparison indicates that the predicted image appears closer to the actual image.

As shown, the varying density on the significant scale value 602 axis indicates that the distribution of scale values that can cause at least a one pixel shift is non-linear, suggesting why the set of significant scale value may be determined in advance. Additionally, as many similar scale values can result in comparable score from the photometric comparison, it may be useful to skip generating a predicted image for each significant scale value. In some cases, not every significant scale value may be tested (e.g., generating a predicted image and comparing the predicted image to the actual image). Instead, significant scale value may be skipped based on a pattern, such as by skipping every other significant scale value, every two significant scale value, etc. This skipping may also be based on the scale value itself, for example, skipping every other significant scale value when the significant scale value is under. 0.5 m, and then not skipping significant scale values after 0.5 m. Skipping significant scale value may be stopped and skipped significant scale values tested by detecting when a peak photometric comparison score has been passed (e.g., photometric comparison scores which have been rising for a number of tested significant scale values begins to fall).

In some cases, blurring may also be used to reduce a number of significant scale values to be tested. For example, blurring the images of the first camera and second camera may blend the pixel information from neighboring pixels, allowing more significant scale values to be skipped while still being able to identify, for example, significant scale values near an optimum significant scale value (e.g., by detecting a peak photometric comparison score has been passed).

In some cases, the techniques (e.g., generation of predicted images and photometric comparison) described above may be applied to 3D object points as well as to 2D object points, and thus may be used for any 3D object (e.g., hands, a toy, statue, ball, etc.), as well as planar objects/targets such as images. Additionally, predicted images for the photometric comparison may be generated using a single camera in cases where the single camera may be moved to obtain other images from spatially different viewpoints at a later point in time. This assumes that the target does not move with respect to the environment in the time between the movement of the camera to capture the two images.

In some cases, a significant scale value with a highest score may be used as a starting point for a nonlinear optimization to refine the scale. For example, the estimated scale determined based on the photometric comparison may be applied to determine a transformation for mapping coordinates of the target object in an image from a first camera to coordinates for a second camera using a formulation framed in an internal object scale space, as described above. Non-linear optimization may then be performed by applying a determined significant scale value, performing a photometric comparison to determine a difference (e.g. error value) or correlation between the translated view and an actual view and performing a non-linear optimization problem (e.g., based on gradient descent, such as using the Gauß-Newton algorithm, the Levenberg-Marquardt algorithm, etc.) to fine-tune the significant scale value to an actual scale value. In some cases, a gradient may be determined based on the comparison (e.g., the photometric comparison to determine the difference or correlation) between the translated view and the actual view and this gradient may be used to refine the scale value. This refined scale value may be used to generate another translated view to be compared to the actual view. These steps may be iteratively repeated to converge to an actual scale value.

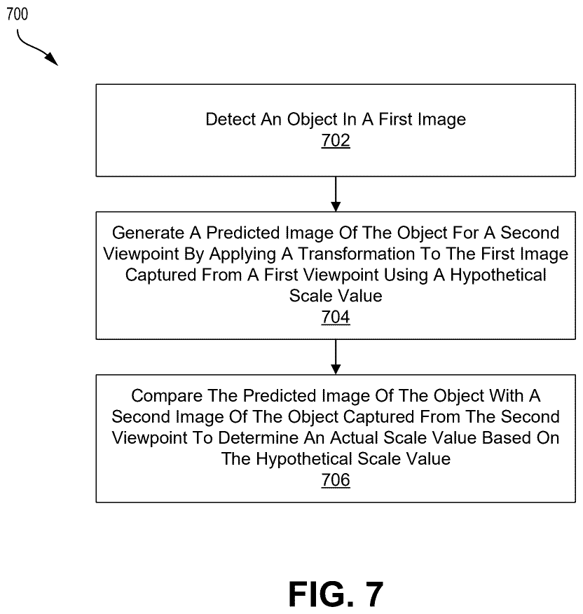

FIG. 7 is a flow diagram illustrating a process 700 for scale estimation, in accordance with aspects of the present disclosure. The process 700 may be performed by a computing device (or apparatus) or a component (e.g., a chipset, codec, etc.) of the computing device (e.g., image capture and processing system 100, of FIG. 1, XR system 200 of FIG. 2, augmented reality enhanced application engine 300 of FIG. 3, computing system 800 of FIG. 8, etc.). The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 700 may be implemented as software components that are executed and run on one or more processors (e.g., image processor 150, host processor 152 of FIG. 1, compute components 210 of FIG. 2, processor 810 of FIG. 8, etc.).

At block 702, the computing device (or component thereof) may detect an object (e.g., target 504 of FIG. 5) in a first image (e.g., first image 502 of FIG. 5). In some examples, the computing device (or component thereof) may include a first camera for capturing the first image and a second camera for capturing the second image. In some cases, the computing device (or component thereof) may track the object.

At block 704, the computing device (or component thereof) may generate a predicted image (e.g., predicted images 512 of FIG. 5) of the object for a second viewpoint by applying a transformation (e.g., transformation between cameras 516 of FIG. 5) to the first image captured from a first viewpoint using a hypothetical scale value. In some cases, the transformation is based on an internal scale space associated with the first image and a metric scale space.

At block 706, the computing device (or component thereof) may compare the predicted image of the object with a second image (e.g., second image 508 of FIG. 5) of the object captured from the second viewpoint to determine an actual scale value based on the hypothetical scale value. In some cases, the computing device (or component thereof) may perform a photometric comparison between the predicted image of the object and the second image of the object. In some examples, the photometric comparison comprises one of a normalized cross coefficient or normalized cross correlation. In some cases, the hypothetical scale value is selected to generate at least one pixel shift in the predicted image of the object as compared to a second predicted image of the object. In some cases, the computing device (or component thereof) may determine a set of significant scale values and determine to skip determining a predicted image of the object for a significant scale value of the set of significant scale values. In some examples, a significant scale value is selected to generate at least one pixel shift in the predicted image of the object as compared to a second predicted image of the object associated with another significant scale value. In some cases, the computing device (or component thereof) may blur the predicted image of the object and the second image of the object before comparing the predicted image of the object with second image of the object. In some examples, the computing device (or component thereof) may perform an iterative nonlinear optimization based on a difference between the predicted image of the object and the second image of the object to refine the hypothetical scale value to the actual scale value. An iterative process or technique may refer to a process/technique that may be applied to a result from a previous application of the process/technique.

As noted herein, the techniques or processes described herein (e.g., the process 700) may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 700 and/or other processes described herein may include a processor, microprocessor, micro-computer, or other component of a device that is configured to carry out the steps of the process 700 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 700 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 700 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 700 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a diagram illustrating an example of a system for implementing certain aspects of the present technology. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some examples, computing system 800 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example computing system 800 includes at least one processing unit (e.g., CPU or processor 810) and connection 805 that couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, camera, accelerometers, gyroscopes, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some examples, a hardware service that performs a particular function can include the software component stored in a computer-readable medium in connection with the necessary hardware components, such as processor 810, connection 805, output device 835, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include:

Aspect 1. An apparatus for scale estimation, comprising: at least one memory; and at least one processor coupled to the at least one memory, the at least one processor being configured to: detect an object in a first image; generate a predicted image of the object for a second viewpoint by applying a transformation to the first image captured from a first viewpoint using a hypothetical scale value; and compare the predicted image of the object with a second image of the object captured from the second viewpoint to determine an actual scale value based on the hypothetical scale value.

Aspect 2. The apparatus of Aspect 1, wherein the at least one processor is configured to perform a photometric comparison between the predicted image of the object and the second image of the object.

Aspect 3. The apparatus of Aspect 2, wherein the photometric comparison comprises one of a normalized cross coefficient or normalized cross correlation.

Aspect 4. The apparatus of any of Aspects 1-3, wherein the transformation is based on an internal scale space associated with the first image and a metric scale space.

Aspect 5. The apparatus of any of Aspects 1-4, wherein the hypothetical scale value is selected to generate at least one pixel shift in the predicted image of the object as compared to a second predicted image of the object.

Aspect 6. The apparatus of any of Aspects 1-5, wherein the at least one processor is configured to: determine a set of significant scale values, wherein a significant scale value is selected to generate at least one pixel shift in the predicted image of the object as compared to a second predicted image of the object associated with another significant scale value; and determine to skip determining a predicted image of the object for a significant scale value of the set of significant scale values.

Aspect 7. The apparatus of any of Aspects 1-6, wherein the at least one processor is configured to blur the predicted image of the object and the second image of the object before comparing the predicted image of the object with second image of the object.

Aspect 8. The apparatus of any of Aspects 1-7, wherein the at least one processor is configured to track the object.

Aspect 9. The apparatus of any of Aspects 1-8, wherein the apparatus includes a first camera for capturing the first image and a second camera for capturing the second image.

Aspect 10. The apparatus of any of Aspects 1-9, wherein the at least one processor is configured to perform an iterative nonlinear optimization based on a difference between the predicted image of the object and the second image of the object to refine the hypothetical scale value to the actual scale value.

Aspect 11. A method for scale estimation, comprising: detecting an object in a first image; generating a predicted image of the object for a second viewpoint by applying a transformation to the first image captured from a first viewpoint using a hypothetical scale value; and comparing the predicted image of the object with a second image of the object captured from the second viewpoint to determine an actual scale value based on the hypothetical scale value.

Aspect 12. The method of Aspect 11, further comprising performing a photometric comparison between the predicted image of the object and the second image of the object.

Aspect 13. The method of Aspect 12, wherein the photometric comparison comprises one of a normalized cross coefficient or normalized cross correlation.

Aspect 14. The method of any of Aspects 11-13, wherein the transformation is based on an internal scale space associated with the first image and a metric scale space.

Aspect 15. The method of any of Aspects 11-14, wherein the hypothetical scale value is selected to generate at least one pixel shift in the predicted image of the object as compared to a second predicted image of the object.

Aspect 16. The method of any of Aspects 11-15, further comprising: determining a set of significant scale values, wherein a significant scale value is selected to generate at least one pixel shift in the predicted image of the object as compared to a second predicted image of the object associated with another significant scale value; and determining to skip determining a predicted image of the object for a significant scale value of the set of significant scale values.

Aspect 17. The method of any of Aspects 11-16, further comprising blurring the predicted image of the object and the second image of the object before comparing the predicted image of the object with second image of the object.

Aspect 18. The method of any of Aspects 11-17, further comprising tracking the object.

Aspect 19. The method of any of Aspects 11-18, further comprising performing an iterative nonlinear optimization based on a difference between the predicted image of the object and the second image of the object to refine the hypothetical scale value to the actual scale value.

Aspect 20. A non-transitory computer-readable medium having stored thereon instructions that, when executed by at least one processor, cause the at least one processor to: detect an object in a first image; generate a predicted image of the object for a second viewpoint by applying a transformation to the first image captured from a first viewpoint using a hypothetical scale value; and compare the predicted image of the object with a second image of the object captured from the second viewpoint to determine an actual scale value based on the hypothetical scale value.

Aspect 21: The non-transitory computer-readable medium of Aspect 20, wherein the instruction causes the at least one processor to perform one or more operations according to any of Aspects 11-19.

An apparatus for image reprojecting, comprising means for performing one or more of operations according to any of Aspects 11 to 19.

What is claimed is:

1. An apparatus for scale estimation, comprising:
at least one memory; and
at least one processor coupled to the at least one memory, the at least one processor being configured to:
detect an object in a first image;
generate a predicted image of the object for a second viewpoint by applying a transformation to the first image captured from a first viewpoint using a hypothetical scale value; and
compare the predicted image of the object with a second image of the object captured from the second viewpoint to determine an actual scale value based on the hypothetical scale value.

2. The apparatus of claim 1, wherein the at least one processor is configured to perform a photometric comparison between the predicted image of the object and the second image of the object.

3. The apparatus of claim 2, wherein the photometric comparison comprises one of a normalized cross coefficient or normalized cross correlation.

4. The apparatus of claim 1, wherein the transformation is based on an internal scale space associated with the first image and a metric scale space.

5. The apparatus of claim 1, wherein the hypothetical scale value is selected to generate at least one pixel shift in the predicted image of the object as compared to a second predicted image of the object.

6. The apparatus of claim 1, wherein the at least one processor is configured to:
determine a set of significant scale values, wherein a significant scale value is selected to generate at least one pixel shift in the predicted image of the object as compared to a second predicted image of the object associated with another significant scale value; and
determine to skip determining a predicted image of the object for a significant scale value of the set of significant scale values.

7. The apparatus of claim 1, wherein the at least one processor is configured to blur the predicted image of the object and the second image of the object before comparing the predicted image of the object with second image of the object.

8. The apparatus of claim 1, wherein the at least one processor is configured to track the object.

9. The apparatus of claim 1, wherein the apparatus includes a first camera for capturing the first image and a second camera for capturing the second image.

10. The apparatus of claim 1, wherein the at least one processor is configured to perform an iterative nonlinear optimization based on a difference between the predicted image of the object and the second image of the object to refine the hypothetical scale value to the actual scale value.

11. A method for scale estimation, comprising:
detecting an object in a first image;
generating a predicted image of the object for a second viewpoint by applying a transformation to the first image captured from a first viewpoint using a hypothetical scale value; and
comparing the predicted image of the object with a second image of the object captured from the second viewpoint to determine an actual scale value based on the hypothetical scale value.

12. The method of claim 11, further comprising performing a photometric comparison between the predicted image of the object and the second image of the object.

13. The method of claim 12, wherein the photometric comparison comprises one of a normalized cross coefficient or normalized cross correlation.

14. The method of claim 11, wherein the transformation is based on an internal scale space associated with the first image and a metric scale space.

15. The method of claim 11, wherein the hypothetical scale value is selected to generate at least one pixel shift in the predicted image of the object as compared to a second predicted image of the object.

16. The method of claim 11, further comprising:
determining a set of significant scale values, wherein a significant scale value is selected to generate at least one pixel shift in the predicted image of the object as compared to a second predicted image of the object associated with another significant scale value; and
determining to skip determining a predicted image of the object for a significant scale value of the set of significant scale values.

17. The method of claim 11, further comprising blurring the predicted image of the object and the second image of the object before comparing the predicted image of the object with second image of the object.

18. The method of claim 11, further comprising tracking the object.

19. The method of claim 11, further comprising performing an iterative nonlinear optimization based on a difference between the predicted image of the object and the second image of the object to refine the hypothetical scale value to the actual scale value.

20. A non-transitory computer-readable medium having stored thereon instructions that, when executed by at least one processor, cause the at least one processor to:
detect an object in a first image;
generate a predicted image of the object for a second viewpoint by applying a transformation to the first image captured from a first viewpoint using a hypothetical scale value; and
compare the predicted image of the object with a second image of the object captured from the second viewpoint to determine an actual scale value based on the hypothetical scale value.
